(19) United States
(12) Patent Application Publication
(10) Pub. No.: US 2009/0103853 A1
(43) Pub. Date: Apr. 23, 2009

(54) Interactive Surface Optical System

(76) Inventor: Tyler Jon Daniel, Tokyo (JP)

Correspondence Address: TYLER DANIEL, DAITA 2-2-19, WHITE ROOM 105, SETAGAYA-KU, 155-0033, JP

(21) Appl. No.: 12/255,752

(22) Filed: Oct. 22, 2008

Related U.S. Application Data
(60) Provisional application No. 60/981,522, filed on Oct. 22, 2007.

(51) Int. Cl. G02B 6/00

(52) U.S. Cl. 385/13

(57) ABSTRACT

A device capable of obtaining information about objects both in contact with a surface and near to, but not in contact with, a surface of the device. The information may include position relative to the surface, pressure when in contact with the surface, shape of the object or objects, and many other properties. Certain embodiments make use of optical waveguides comprising a photoluminescent material which responds to first electromagnetic radiation of a first spectrum propagated through the system by emitting second electromagnetic radiation of a second spectrum. The distribution of the first electromagnetic radiation is altered by pressure on the surface or by the presence of objects near the surface of the device. The distribution of the second electromagnetic radiation is measured using photosensors and processed to determine desired information.

### CROSS-REFERENCE TO RELATED APPLICATIONS

The application claims the benefit of provisional patent application Ser. No. 60/981,522, filed Oct. 22, 2007 by the present inventor.

### FEDERALLY SPONSORED RESEARCH

Not Applicable

### SEQUENCE LISTING OR PROGRAM

Not Applicable

### BACKGROUND

1. Field of the Invention

The invention relates to the field of optical systems, more particularly, user interface optical systems, and, even more particularly, user interface optical systems that are responsive to pressure such as touch input devices

2. Background of the Invention

The term “interactive surface” is used in this document to describe devices which are responsive to input from a user. In particular, interactive surface devices may display information to a user on a surface and accept input from a user on the same surface.

One class of coordinate input device especially related to the present invention is the touch panel, particularly the transparent touch panel. Existing transparent touch panels can be grouped generally into four classes: capacitive, resistive, acoustic, and optical. Capacitive and resistive devices rely on transparent electrically conductive coatings of materials including ITO which are difficult and expensive to manufacture. Such systems also exhibit poor transparency. Acoustic systems show poor accuracy and are adversely affected by environmental factors including dirt and oil which can accumulate on the surface of the device. Existing optical systems are most often of the type forming a lamina of light above the interaction surface. These optical systems generally have poor accuracy and do not sense touch, but rather proximity resulting in poor usability. Another type of optical touch panel is based on frustrated total internal reflection (FTIR) using an out-of-plane imaging device and image processing algorithms to locate contact points. This type of device requires an expensive high-resolution camera, complex computer vision processing, and a large distance between the imaging sensor and interaction surface making it impractical for many applications. FTIR systems are described in U.S. Pat. Appl. 20030137494 by Tulbert and U.S. Pat. Appl. 20080179507 by Han, both incorporated herein by reference.

### SUMMARY OF THE INVENTION

A new type of interactive surface is presented which may be simply and inexpensively implemented. The invention is capable of obtaining information about objects both in contact with the surface and near to, but not in contact with, the surface. The information may include position relative to the surface, pressure when in contact with the surface, shape of the object or objects, and many other properties. Some embodiments make use of optical waveguides comprising a photoluminescent material which responds to electromagnetic radiation propagated through the system. The distribution of electromagnetic radiation is altered by pressure on the surface or presence of objects near the surface. The distribution is measured using photosensors.

### BRIEF DESCRIPTION OF THE DRAWINGS

The invention will now be described, by way of example, with reference to the accompanying drawings, wherein:

FIG. 1A is an isometric illustration of an interactive surface having a deformable waveguide layer.

FIG. 1B is a cross-sectional view of the interactive surface of FIG. 1A.

FIG. 2 shows an interactive surface in cross-section having a deformable waveguide layer.

FIG. 3 shows an interactive surface in cross-section have a layer of deformable objects separating two light-conducting layers.

FIG. 4 is a cross-sectional view of an interactive surface having a blocking layer separating two light-conducting layers.

FIG. 5 illustrates a method of dividing an interactive surface into smaller tracking regions.

FIG. 6 illustrates another method of dividing an interactive surface into smaller tracking regions.

FIG. 7 is a cross-sectional view of a photoluminescent waveguide used to transmit information optically.

FIG. 8 shows an interactive surface in cross-section which collects ambient light for touch detection.

FIG. 9 is an isometric, exploded view of an interactive surface which encodes positional information along its edges.

FIG. 10 is an isometric, exploded illustration of another interactive surface which encodes positional information along its edges.

FIG. 11 is an isometric illustration of a method of encoding positional information at one or more light sources.

FIG. 12 is an isometric illustration of another method of encoding positional information at one or more light sources.

FIG. 13 is an isometric, exploded view of an interactive surface with retro-reflective edges.

FIG. 14 is an isometric, exploded view of an interactive surface having a mirrored edge.

FIG. 15 is an isometric, exploded illustration of another method of dividing an interactive surface into smaller tracking regions.

FIG. 16 is an exploded, isometric view of an interactive surface making use of wavelength-selective mirrors to “label” images of contact points.

FIG. 17A is a cross-sectional illustration of the projection by an imager of points on a waveguide and their reflections.

FIG. 17B is a top view of a waveguide patterned to sample incoming light.

FIG. 17C illustrates the output of an imager viewing light propagated along the waveguide of FIG. 17B.

FIG. 18 is an isometric illustration of a method of sensing objects near an interactive surface.

FIG. 19 is a cross-sectional view of a display device with photoluminescent features and a method of change the color of the features.

FIG. 20 is an isometric, exploded view of an interactive surface with features that become visible when touched.

FIG. 21 is an isometric, exploded view of a backlit display device which remains readable in high levels of ambient light.

FIG. 22 is a cross-sectional view of a method of coupling light into a waveguide.

### DETAILED DESCRIPTION

This application is closely related to and builds upon the techniques presented in co-pending U.S. patent application Ser. No. 11/867,691 previously filed by the inventor, which is incorporated herein by reference.

### DEFINITIONS

The term “light” is used in this document in its most general sense to mean “electromagnetic radiation.”

The term “spectrum” is used to denote a set of wavelengths. Two spectra are said to “overlap” if they contain some of the same wavelengths. Two spectra are said not to overlap, or to be “distinct” if they do not have any wavelengths in common. It is to be understood that in most contexts a spectrum is said not to contain a wavelength λ if the magnitude of wavelength λ is relatively very small, i.e., most materials and light sources are described by spectra that gradually fall off rather than begin or end abruptly. The exact permissible magnitude varies by application.

The term “optical” as used herein, broadly relates to systems and devices that employ or transmit electromagnetic radiation.

As used herein, the term “waveguide” is used in its broadest sense of any material, regardless of shape or configuration, that is a conduit which facilitates passage or transmits electromagnetic waves. More particularly, the term “waveguide” does not imply a particular cladding or refractive index layer structure of a material as long as that material performs the above functions. Thus, for example, a waveguide may be a material having a single refractive index; material surrounding the waveguide with a different refractive index, such as air, may perform cladding-like functions in particular applications.

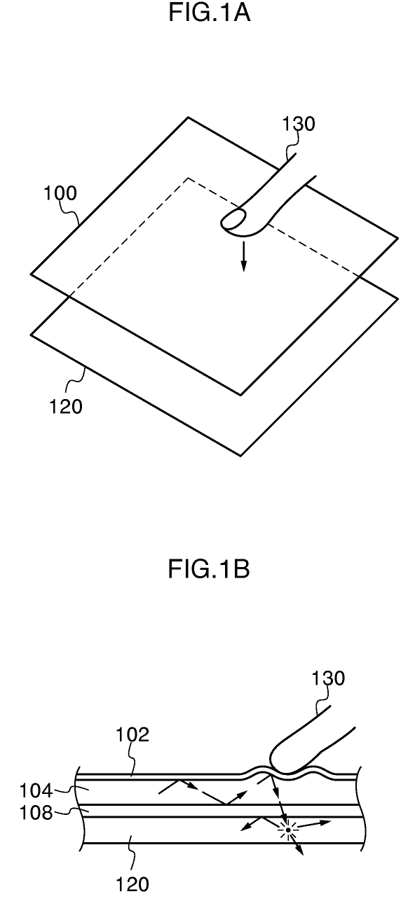

Turning to the drawings in detail in which like reference numerals indicate the same or similar elements in each of the several views, FIG. 1A shows an exploded, perspective view of an interactive surface according to an embodiment of the present invention. A finger 130 presses down on a waveguide 100 arranged parallel and near to a rigid, photoluminescent waveguide 120. FIG. 1B is a cross-sectional view from the side of the area immediately surrounding finger 130. Waveguide 100 propagates by internal reflection light of a first spectrum at least partially coinciding with the excitation spectrum of waveguide 130, as described in the '691 patent application referenced above. Waveguide 100 is composed of a lower, light-conducting layer 104 and an upper layer 102. Both layers 102 and 104 are deformable and flexible. Layer 102 has a refractive index lower than that of layer 104. Both layers 102 and 104 are substantially transparent to light of the first spectrum. Waveguide 120 is separated from layer 104 by a region 108 of refractive index less than that of layer 104, such that light of the first spectrum propagates in layer 104 by internal reflection.

At the point where finger 130 presses down on waveguide 100, layers 102 and 104 are deformed, changing the angle at which light of the first spectrum strikes the boundary between layers. As a result, some light is reflected towards waveguide 120 at an angle high enough to escape waveguide 100, resulting in absorption and emission of light of a second spectrum by photoluminescence in the interior of waveguide 120. Waveguide 120 is surrounded by material substantially transparent to light of the second spectrum and having a refractive index less than that of waveguide 120. Light of the second spectrum then propagates anisotropically along waveguide 120 through internal reflection. The thicknesses of the layers shown in FIG. 1B has been exaggerated for explanatory purposes. The total thickness of all layers shown in FIG. 1B is preferably less than 20 mm and more preferably less than 10 mm.

The location of the photoluminescent emission in layer 120 may be tracked using any of the methods of the present invention or any of the methods presented in the co-pending '691 application referenced above. Tracking methods include but are not limited to lateration using distances calculated from the signals of a plurality of photosensors (not shown) and angulation using angles calculated using one or more imaging devices (not shown).

Suitable materials for the construction of layer 104 include polyurethane elastomers. Suitable materials for the construction of layer 102 include silicone- and siloxane-based elastomers. Region 108 may comprise any material having a refractive index less than layer 104 and waveguide 120 and having appropriate transparency including air and the material used to construct layer 102.

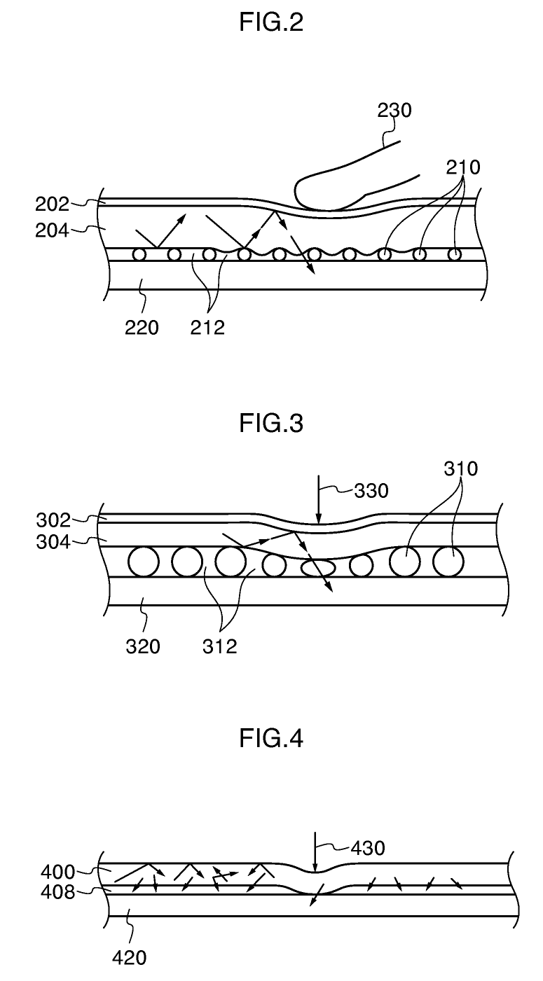

FIG. 2 shows a partial, cross-sectional view of an interactive surface according to another embodiment of the present invention, similar to the embodiment of FIGS. 1A and 1B. A finger 230 presses down on the surface deforming a waveguide composed of an upper layer 202 and a lower layer 204. Layer 204 is similar to layer 104 of the previous embodiment, being deformable and flexible. Layer 202 is easily flexed but is more rigid than layer 204. A layer of microbeads 210 are arranged between layer 204 and a rigid, photoluminescent waveguide 220. A region 212 surrounding microspheres 210 and between layer 204 and waveguide 220 has a refractive index less than that of layer 204 and waveguide 220.

Stimulating light is propagated along layer 204 by internal reflection as in previous embodiments until reaching the area near finger 230. The downward pressure by finger 230 flexes layer 202 forcing layer 204 against microspheres 210. Layer 204 is deformed against microspheres 210, changing the angle at which stimulating light strikes the lower surface of layer 204. As a result, some light escapes layer 204 and stimulates a photoluminescent emission in waveguide 220. The location of the emission in waveguide 220 is then determined as described elsewhere.

Suitable materials for the construction of layer 202 include air, polymethyl-methacrylate (PMMA), and various low-index fluoropolymers. Region 212 may comprise any transparent fluid of appropriately low refractive index including vacuum, air and silicone oil. Region 212 may have a refractive index close to that of microspheres 210 such that microspheres 210 do not refract or distort light passing through the device, for example light from a display located beneath the device.

Microspheres 210 are preferably composed of transparent material with a refractive index less than that of layer 204 and waveguide 220, but this is not essential as the area of contact between microspheres 210 and layer 204 is small. Microspheres 210 are also preferably small enough to be nearly invisible to a user. Glass microspheres of diameters between 5 and 100 micrometers are suitable for the construction of the present embodiment. Other suitable materials include fine powders of rigid materials which may be transparent or opaque. Other embodiments use rigid, non-spherical structures to deform layer 204, including transparent fibers of glass and polymer. Still other embodiments secure microspheres 210 to either layer 204 or waveguide 220 with a transparent adhesive.

Alternatively, region 212 could be any other material that enhances coupling between two waveguides and may by discontinuous/plural materials, as shown, or a single material. The function of microspheres 210 is to locally deform layer 204 and, as such, any structure including non-spherical structures which locally deform layer 204 may be used in place of microspheres 210.

Other embodiments similar to the embodiment of FIG. 2 provide a layer of rigid microspheres between a flexible, upper, photoluminescent waveguide and a lower, deformable waveguide which conducts stimulating light.

FIG. 3 shows yet another cross-sectional, side view of an interactive surface according to an embodiment of the present invention. A downward force 330 is exerted on a waveguide composed of layers 302 and 304, which are arranged to propagate stimulating light by internal reflection, as in previous embodiments. Layers 302 and 304 are composed of transparent, flexible materials. A layer of transparent, flexible microspheres 310 is provided between layer 304 and a photoluminescent waveguide 320. A region 312 surrounding microspheres 310 between layer 304 and waveguide 320 has a refractive index less than layer 304 and waveguide 320. Microspheres 310 have a refractive index greater than that of layer 302 and region 312 which is preferably close to the refractive indices of layer 304 and waveguide 320.

Light propagates along layer 304 by internal reflection until reaching the area distorted by downward force 330. Microspheres 310 are compressed near downward force 330 resulting in a large surface area of microspheres 310 in contact with both layer 304 and waveguide 320. Some of the light propagating along layer 304 travels through the compressed area of microspheres 310 into waveguide 320, resulting in a photoluminescent emission in layer 320, which is tracked as in previous embodiments.

Materials suitable for the construction of microspheres 310 include polyurethane elastomer. Microspheres 310 may be replaced with other deformable structures including cylindrical fibers, as will be apparent to a skilled practitioner.

Still another embodiment of the present invention is similar to the embodiment of FIG. 3 except that a lower waveguide corresponding to waveguide 320 is not made of photoluminescent material. The lower waveguide of the current embodiment is simply transparent, propagating light coupled by pressure on the upper surface of the device from an upper waveguide by internal reflection. The location at which light is coupled from the upper waveguide to the lower waveguide is tracked using methods described in this application and in the co-pending '691 application.

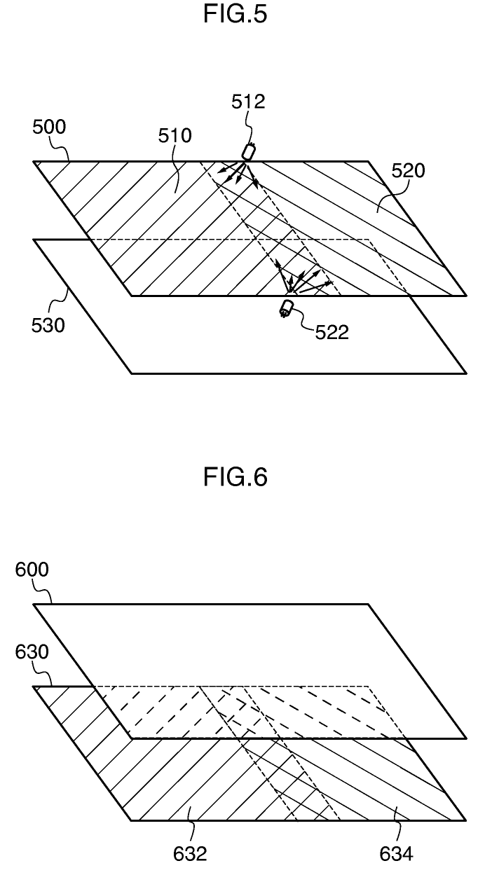

FIG. 4 shows a partial, cross-sectional view of still another embodiment similar in construction to the above embodiments. A downward force 430 locally deforms a flexible, light-conducting layer 400 and a deformable, flexible blocking layer 408. A lower, photoluminescent waveguide 420 is provided below blocking layer 408.

Stimulating light travels along layer 400, which is configured to “leak” the light in the direction of blocking layer 408 and waveguide 420. Light leaked in areas far from downward force 430 is absorbed by blocking layer 408. In areas close to downward force 430, blocking layer 408 is distorted such that the distance separating layer 400 and waveguide 420 is much smaller than areas where blocking layer 408 is undistorted. In the case where blocking layer 408 comprises a fluid, layer 400 and waveguide 420 may be brought into contact, completely excluding blocking layer 408. In areas near downward force 430, therefore, light leaked from layer 400 is partially or completely transmitted to reach waveguide 420. Upon reaching waveguide 420, the light causes a photoluminescent emission, which is tracked as in other embodiments.

Layer 408 may comprise materials well-known to those skilled in the art, including transparent fluid and elastomers dyed to absorb the stimulating light.

Many techniques exist to direct light from layer 400 towards blocking layer 408 such as those used in the construction of backlights and frontlights used in liquid crystal displays (LCDs), and are well-known to those skilled in the art. One simple method of constructing waveguide 400 comprises embedding small, high-refractive index, transparent particles which scatter light in a waveguide of lesser refractive index. Materials suitable for the construction of such a waveguide include silicon dioxide particles and PMMA for the waveguide.

Still another embodiment is similar to the embodiment of FIG. 4, reversing the positions of an light-leaking layer and a photoluminescent waveguide. In this embodiment the photoluminescent waveguide is composed of a flexible material and placed to receive a downward force. The light-leaking layer is disposed adjacent to the side of the photoluminescent waveguide not receiving the downward force.

FIG. 5 is an exploded, isometric view of still another interactive surface device according to an embodiment of the present invention. An upper waveguide 500 is disposed near and parallel to a lower waveguide 530. The device is configured using any appropriate method such that light is coupled from waveguide 500 into waveguide 530 at any point where sufficient force is applied to waveguide 500 or waveguide 530. A tracking system (not shown) is provided to determine the location or locations of a point or points where force is applied. A light source 512 is configured to inject light into waveguide 500 such that the light propagates only in a region 510 of waveguide 500. A light source 522 is configured to inject light into waveguide 500 such that the light propagates only in a region 520 of waveguide 500.

Light sources 512 and 522 are activated sequentially such that only one light source is activated at any given time. Sufficient force at any given point causes light to be coupled from waveguide 500 to waveguide 530 only when light is present in the region containing the point. The tracking system is synchronized with light sources 512 and 522. When force is applied simultaneously to a point in region 510 and to a point in region 520, the tracking system need only detect one point at a time. The number of points that must be simultaneously detected by the tracking system is therefore reduced by effectively dividing the surface of the device into two regions, i.e., region 510 and region 520. Other embodiments divide an interactive surface into more than two regions to further reduce demands on the associated tracking system.

FIG. 6 is an exploded, isometric view of another embodiment of the present invention. An upper waveguide 600 and lower, photoluminescent waveguide 630 are provided, along with a tracking system which is not shown. A coupling means is provided for coupling light from waveguide 600 into waveguide 630 at a point or points where sufficient force is applied to either waveguide 600 or waveguide 630. The coupling means is also not shown in FIG. 6. Waveguide 630 contains two regions, a region 632 and a region 634. Region 632 emits light by photoluminescence when illuminated by light of a spectrum A, and region 634 emits light by photoluminescence when illuminated by light of a spectrum B. Spectrums A and B do not overlap.

Light of spectrum A is propagated by waveguide 600 such that force applied to points in region 632 causes photoluminescent emissions in waveguide 630 which are detected by the tracking system. Light of spectrum B is then propagated by waveguide 600 such that force applied to points in region 634 causes photoluminescent emissions in waveguide 630 which are detected by the tracking system. Light of only one of spectra A or B is propagated by waveguide 600 at any one time. In this manner the demands on the number of points able to be detected simulataneously by the tracking system are reduced. This embodiment is similar to that of FIG. 5 in that a sensing surface may be effectively divided into regions, reducing demands on the associated tracking system. Although a simple on-off scheme is used in the present embodiment, many other means of distinguishing points in region 632 from those in region 634 including carrier modulation/demodulation are appropriate and well-known to those skilled in the art.

One method of creating waveguide 630 is to bond a filter layer patterned with two absorbing dyes A and B to a photoluminescent waveguide of excitation spectrum C. Region 632 of the filter layer is dyed with dye A and region 634 of the filter layer is dyed with dye B. Spectrum C contains both spectra A and B. Dye A passes spectrum A and at least part of the emission spectrum of the photoluminescent waveguide, but not spectrum B. Similarly, dye B passes spectrum B and part of the emission spectrum of the photoluminescent waveguide, but not spectrum A. Appropriate materials, as well as other appropriate configurations of waveguide 630, are familiar to those skilled in the art.

The techniques described for the embodiments of FIGS. 5 and 6 may also be used to conserve power. When a tracking system detects no points of contact in a region of a touch-sensitive device for a given amount of time, the frequency at which the tracking system attempts to detect points in that region may be reduced. The reduced tracking frequency means that light used to detect points of contact in the associated region need only be emitted at the reduced frequency, correspondingly reducing the amount of power spent on light production. This technique is commonly used in the construction of wireless optical mice, for example.

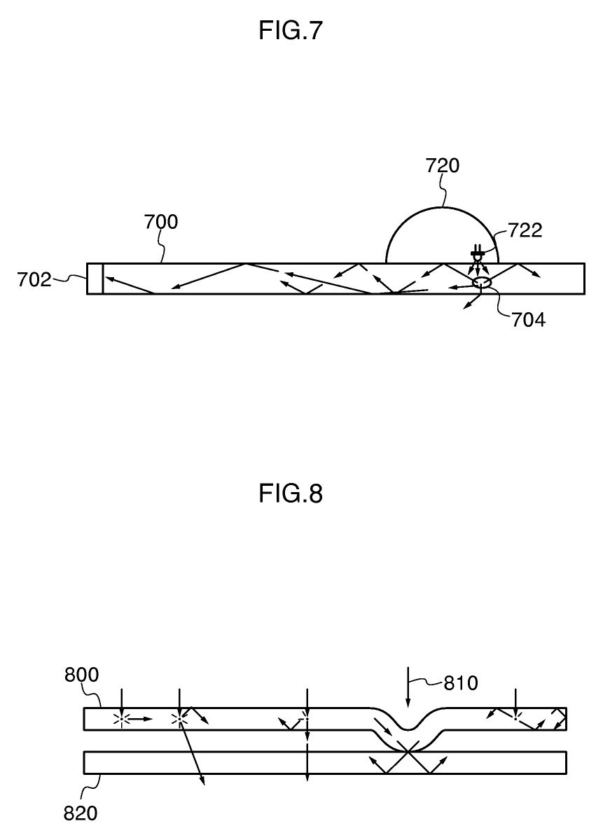

FIG. 7 shows a partial, cross-sectional view of yet another embodiment of the present invention. An interactive surface device contains a photoluminescent waveguide 700 in optical communication with a photosensor 702. An object 720 rests on top of waveguide 700. Object 720 contains a light source 722 which emits light in the excitation spectrum of waveguide 700. Light source 722 is modulated to encode information in ways familiar to those skilled in the art including pulse width modulation. Light emitted from light source 722 strikes waveguide 700 which emits light by photoluminescence in a region 704. Some of the light emitted in waveguide 700 propagates by internal reflection until reaching photosensor 702. The light received by photosensor 702 produces an electrical signal which is decoded by a decoding means not shown. Waveguide 700 effectively forms an antenna receiving signals from object 720. Additionally, the location of region 704 may be determined using any appropriate technique, including those presented in this and related applications, yielding information about the location of object 720. Further embodiments provide the interactive surface device with a means of emitting modulated light such as a leaky waveguide and provide object 720 with a means of receiving the modulated light. This type of optical communication is easily and inexpensively implemented, as evidenced by the widespread use of infra-red communication in devices such as remote controls.

FIG. 8 illustrates a further embodiment. Numerous methods of determining the location of regions of light coupled into a waveguide are presented in this application and the co-pending '691 application. FIG. 8 illustrates an alternative method of coupling light into a waveguide which may reduce power requirements. A force 810 is applied to an upper, photoluminescent waveguide 800 causing it to flex and contact a lower waveguide 820. Ambient light from the environment strikes waveguide 800 causing light to be emitted within waveguide 800 by photoluminescence. Some of the light emitted within waveguide 800 is trapped and propagated by internal reflection. The edges of waveguide 800 are optionally mirrored to increase efficiency. The light propagated by waveguide 800 is coupled into waveguide 820 at the point where force 810 is applied. A tracking system not shown is provided according to any appropriate method to determine the location of the point where force 810 is applied. The technique of this embodiment is suitable for tracking a single or multiple unknown points of applied force. Further embodiments reverse the positions of waveguides 800 and 820, with waveguide 820 flexing to contact waveguide 800. In still further embodiments, waveguide 820 contains photoluminescent material excited by the light propagated by waveguide 800. For embodiments where both waveguides are photoluminescent, direct contact between waveguides is unnecessary and embodiments of the present application are applicable including those employing deformable waveguides that “leak” light where locally deformed by pressure.

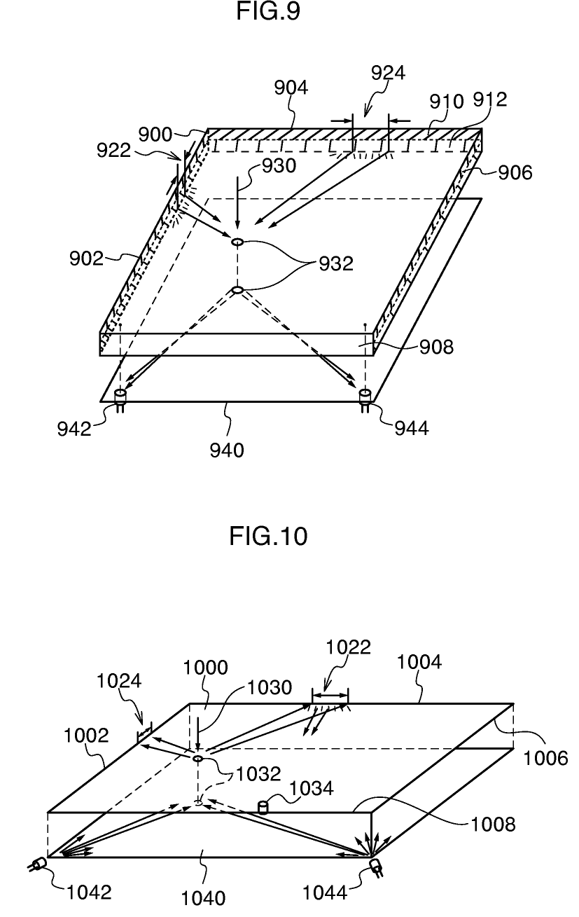

FIG. 9 shows an isometric, exploded view of an interactive surface device according to still another embodiment of the present invention. A waveguide 900 with edges 902, 904, 906, and 908 is arranged parallel and near to a waveguide 940. Edge 908 does not emit or reflect light. Edges 902, 904, and 906 are divided into an upper region 910 and a lower region 912 identified in FIG. 9 by forward and backward slashes or hash marks, respectively. All points in region 910 emit light of a spectrum A at the same intensity in a diffuse manner. Region 912, however, emits light of a spectrum B such that, viewed from above as in FIG. 9, light is emitted at the greatest intensity at the lower corner of edge 902 and at an intensity that decreases going clockwise around the edge of waveguide 900. All points in region 912 emit light at different intensities. The intensity at which points on edges 902, 904, and 906 emit light is roughly illustrated by the density of hatch marks in FIG. 9. Spectra A and B do not overlap. Waveguide 940 is in optical communication with two photosensors 942 and 944. The edges of waveguide 940 are treated to absorb light of spectra A and B.

A downward force 930 brings waveguides 900 and 940 into contact at a point 932. Point 932 effectively forms a “window” allowing light to travel from waveguide 900 into waveguide 940. Some light emitted from edges 902, 904, and 906 travels from waveguide 900 into waveguide 940 at point 932 and continues in straight lines until most of the light is absorbed by the edges of waveguide 940. Some of the light coupled into waveguide 940 at point 932, however, strikes photosensors 942 and 944. The light received by photosensor 942 originates from a region 924 on edge 904 of waveguide 900. Similarly, the light received by photosensor 944 originates from a region 922 on edge 902 of waveguide 900. Photosensors 942 and 944 each produce two output signals corresponding to the amounts of light received by each photosensor of spectra A and B, respectively.

Because each point on edges 902, 904, and 906 emits a constant amount of light of spectrum A and a unique amount of light of spectrum B, the ratio of output signals corresponding to spectra A and B is proportional to the location of the region on the edges of waveguide 900 from which the light originated. For the case of photosensor 942, light is received from region 924 where the intensity of light of spectrum B is slightly less than that of light of spectrum A, as illustrated. For the case of photosensor 944, light is received from region 922 where the intensity of light of spectrum B is greater than that of light of spectrum A, also as illustrated. The ratio of the output signals produced by photosensor 942 therefore indicate the location of region 924, and the ratio of output signals produced by photosensor 944 indicate the location of region 922. The location of point 932 is therefore given by the intersection of the line connecting region 922 and photosensor 944 with the line connecting region 924 and photosensor 942. The relationship of output signal ratio and edge location is determined by factors including the exact distribution of light intensity in region 912 and is easily computed by a skilled practitioner.

One suitable distribution of light intensities for points in region 912 is a linear distribution. The relationship between output signal ratio and location on edges 902, 904, and 906 for each photosensor is easily determined by recording the output signal ratio as a constant downward force is applied to waveguide 900 at a point which is swept along an arc centered at each photosensor.

The greater the magnitude of force 930, the greater the amount of light communicated from waveguide 900 to waveguide 940. The magnitude of force 930 is proportional to the amount of light of spectrum A received by each photosensor and inversely proportional to the distance separating point 932 and each photosensor.

One simple method of computing the magnitude of force 930 proceeds as follows. A force of known and constant magnitude C is applied sequentially to a set of points forming a grid covering the surface of the device of FIG. 9. The amount of light of spectrum A received by each photosensor is recorded for each point forming a first calibration set for each photosensor. The relationship between applied force and the amount of light coupled into waveguide 940 is similarly determined by recording the amount of light of spectrum A coupled into waveguide 940 as a varying force is applied, forming a second calibration set for each photosensor.

When an unknown force is applied to an unknown point, the point's location is computed as described above. A first value is computed from the first calibration set by interpolation at the point's location. The first value indicates the amount of light of spectrum A received by the corresponding photosensor for a force of magnitude C. The first value, together with the amount of light of spectrum A received by each photosensor and the second calibration set for each photosensor then yields the magnitude of the unknown force.

One method of forming regions 910 and 912 is dyeing a diffuse reflecting surface with a constant amount of dye A in region 910 and varying amounts of a dye B in region 912. Dye A absorbs light of spectrum B and transmits light of spectrum A. Dye B absorbs light of spectrum A and transmits light of spectrum B. Region 912 is first treated to absorb all light of spectrum A. Light of a spectrum C containing both spectra A and B is then directed at sides 902, 904, and 906. Color filters in photosensors 942 and 944 may be used to form independent signals corresponding to light of each of spectra A and B.

Alternatively, light of spectra A and B may be alternately directed to sides 902, 904, and 906 such that photosensors 942 and 944 produce signals corresponding to light of spectra A and B separated in time, eliminating the need for color filters. It is to be understood that this multiplexing in time is one of several equivalent alternatives to the system of photosensors with color filters above, and is applicable to other embodiments of the present invention even when not explicitly mentioned.

FIG. 10 shows another embodiment of the present invention, and is similar in principle to the embodiment of FIG. 9. A downward force 1030 is present at a point 1032 in the common plane of a waveguide 1000 and a waveguide 1040. Waveguide 1000 is in optical communication with a photosensor 1034. Waveguide 1000 has four edges 1002, 1004, 1006, and 1008. Edges 1002, 1004, and 1006 are patterned in a manner similar to edges 902, 904, and 906 in FIG. 9 such that each point on edges 1002, 1004, and 1006 reflects the same amount of light of a spectrum A and a unique amount of light of a spectrum B. Therefore, the ratio of the amount of light of spectrum A to the amount of light of spectrum B reflected at each point on edges 1002, 1004, and 1006 is also unique. Spectra A and B do not overlap. Two light sources 1042 and 1044 inject light of a spectrum C into waveguide 1040. Spectrum C contains at least part of spectrum A and at least part of spectrum B. Light source 1042 is first activated injecting light of spectrum C into waveguide 1040. Most of the light is absorbed by the edges of waveguide 1040, which are treated to absorb light of spectrum C. Some of the light, however, travels through the “window” formed at point 1032 into waveguide 1000, where the light continues until striking side 1004 at region 1022. Region 1022 reflects the light, part of the reflected light then reaching photosensor 1034. Photosensor 1034 provides output signals proportional to the amounts of light of spectra A and B received by the sensor. The ratio of the output signals identifies the location of region 1022. Light source 1042 is then deactivated and light source 1044 is activated. Part of the light emitted by light source 1044 strikes region 1024 in waveguide 1000 in the manner previously described for light source 1042. Similarly photosensor 1034 emits output signals whose ratio yields the location of region 1024. The location of point 1032 is then given by the intersection of the line connecting region 1024 and light source 1044 with the line connecting region 1022 and light source 1042. The magnitude of force 1030 is computed using the location of point 1032 and the amount of light received by photosensor 1034 as described for the embodiment of FIG. 9.

Although for this and other embodiments a simple on-off method is used to produce output signals corresponding to the amounts of light coupled into waveguide 1000 by each of light sources 1042 and 1044, many other modulation schemes are possible and well-known to those skilled in the art.

One suitable method of patterning the edges of waveguide 1000 comprises bonding a diffuse paper patterned with inks or pigments to form a constant reflectivity in spectrum A and a linear gradient in spectrum B, which is easily accomplished using a commonly available desktop printer.

For simplicity in this and other embodiments, a quantity is determined using the ratio of a first non-changing value, the amount of light of spectrum A in this embodiment, to a second changing value, the amount of light of spectrum B in this embodiment. However, many other patterns are possible, including many where both first and second values are varying. Any pattern which satisfies the following condition is valid: for any contiguous region of the pattern, the ratio of the integral of the first value over the region to the integral of the second value over the region must be distinct from such a ratio computed for any other contiguous region of the pattern.

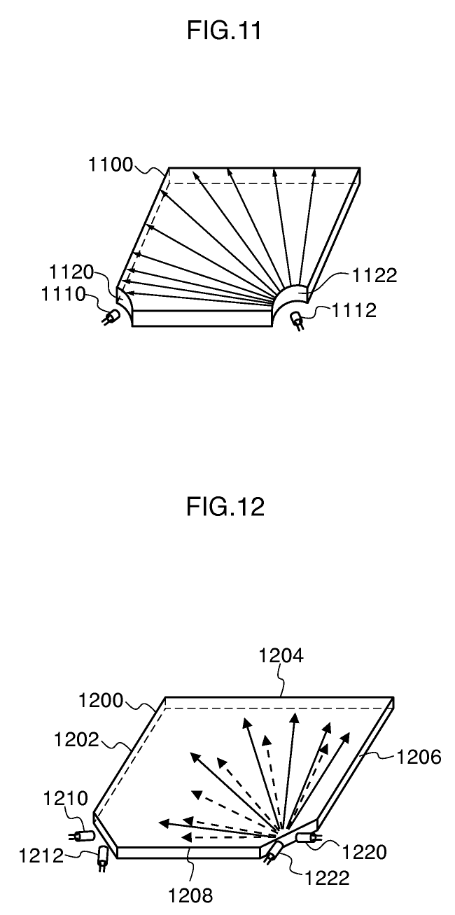

While previous embodiments have modified the properties of light emitted or reflected from the edges of waveguides to encode positional information, the present embodiment modifies the properties of light at or near a light source to encode positional information. The present embodiment comprises a lower waveguide 1100, shown in FIG. 11, and an upper waveguide which is not shown. Waveguide 1100 is analogous to waveguide 1040 of FIG. 10, and the upper waveguide is analogous to waveguide 1000, also of FIG. 10. Two light sources 1110 and 1112 inject light into waveguide 1100 through two circular cuts 1120 and 1122, respectively. Each circular cut is dyed to form a color filter in a pattern analogous to the edge pattern of waveguides 1000 and 900. Each cut passes the same amount of light of a spectrum A at each point and passes varying amounts of light of a spectrum B at each point. Light sources 1110 and 1112 emit light of a spectrum C containing spectra A and B. Effectively, both pairs of light source and cut project a colored pattern analogous to that of waveguides 1000 and 900. The varying amount of light of spectrum B is illustrated by the density of solid arrows in FIG. 11. When a downward force is applied to the device at a point, light travels from waveguide 1100 into the upper waveguide and travels until reaching an edge, similar to the embodiment of FIG. 10. The edges have been treated to diffusely reflect light of spectrum C. Light reflected from the edge reaches a photosensor in optical communication with the upper waveguide. The location of the point at which the downward force is applied is determined using the spectral content of light measured by the photosensor, as in previous embodiments. In this embodiment the upper waveguide acts as a means of sampling light passing through a point at which pressure is applied without affecting the property to be measured, in this case the spectral content, and will henceforth be referred to as a “sampling waveguide.”

Still further embodiments of the present invention modify the distribution of light intensities to encode positional information. A waveguide 1200 having sides 1202, 1204, 1206, and 1208 of one such embodiment is shown in FIG. 12. Four light sources 1210, 1212, 1220, and 1222 inject light into waveguide 1200. Light source 1220 emits light with varying intensity roughly indicated by the long, solid arrows of FIG. 12. Light source 1220 emits light with varying intensity roughly indicated by the short, dashed arrows of FIG. 12. The intensity of light emitted from light source 1220 is greatest near edge 1208 and least near edge 1206, decreasing linearly in between the two edges. The intensity of light from light source 1222, however, is greatest near edge 1206 and least near edge 1208, also decreasing linearly. The intensities of light emitted by light sources 1210 and 1212 is configured in a similar manner to form a second set of gradients. The present embodiment also provides a sampling waveguide not shown in FIG. 12. The intensity of light from each light source at a point of downward force is measured by the sampling waveguide and an associated photosensor, also not shown, to determine the location of the point by any appropriate method of the present invention. The intensities of light from each light source may be individually measured by any appropriate method, including multiplexing the light sources in time and modulating each light source at a different carrier frequency.

Further embodiments employ a photoluminescent sampling waveguide with one or more signal layers in combination with methods from previous embodiments and the methods from the co-pending '691 application.

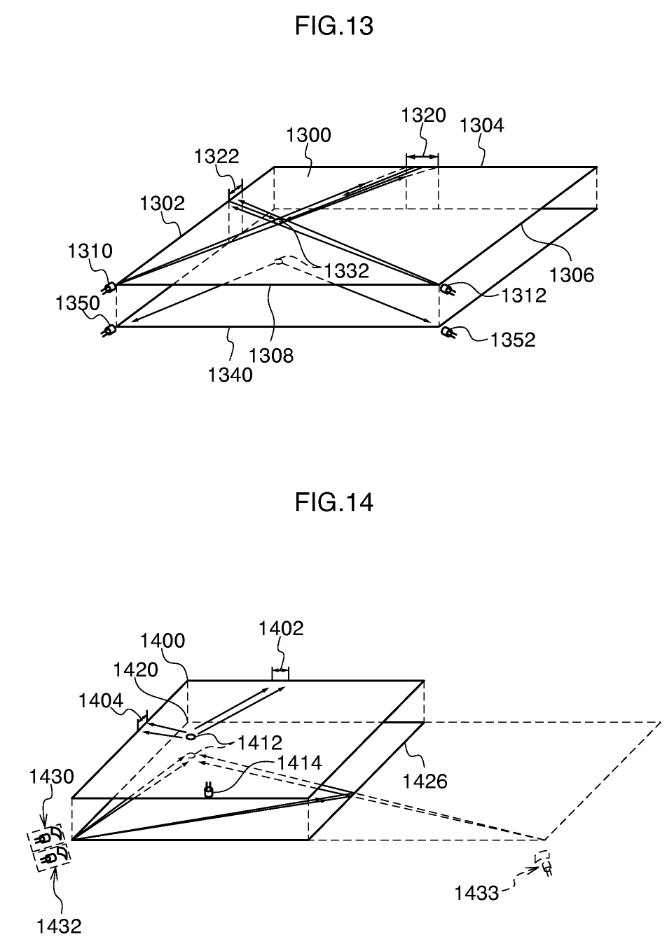

Additional embodiments employ retro-reflective material instead of diffusely reflective material to improve light efficiency. One such embodiment is illustrated in FIG. 13, providing an upper waveguide 1300 and a lower waveguide 1340. Two light sources 1310 and 1312 inject light into waveguide 1300 and are positioned directly above two photosensors 1350 and 1352 which receive light coupled into waveguide 1340 at a point 1332 by a downward force. Waveguide 1300 has three edges 1302, 1304, and 1306 treated with a retro-reflective material that acts to reflect incident light back in the direction of the light source from which it was emitted. An edge 1308 of waveguide 1300 is treated such that no light emitted by light sources 1310 and 1312 is reflected. The edges of waveguide 1340 corresponding to edges 1302, 1304, and 1306 may also be treated with retro-reflective material or be treated so as not to reflect light emitted by light sources 1310 and 1312. The edge of waveguide 1340 corresponding to edge 1308 is treated not to reflect light emitted from light sources 1310 and 1312. In the case where some edges of waveguide 1340 are retro-reflective, the corresponding edges of waveguide 1300 may or may not be treated so as not to reflect light from light sources 1310 and 1312.

Light sensors 1350 and 1352 are positioned at the same location as light sources 1310 and 1312, respectively, in the common plane of waveguides 1300 and 1340, and therefore any retro-reflective edges serve to direct more light toward photosensors 1350 and 1352 compared to other embodiments employing diffuse edges, increasing efficiency. This technique of employing retro-reflective edges is compatible with many other embodiments of the present invention, including those which encode positional information at the light source and those which encode positional information at the edges of a waveguide. Additionally, the use of retro-reflective materials in this configuration prevents light from light source 1310 from reaching photosensor 1352 and prevents light from light source 1312 from reaching photosensor 1350, eliminating cross-talk without the use of multiplexing or modulation techniques.

An exploded view of yet another embodiment is shown in FIG. 14. A sampling waveguide 1400 is provided in optical communication with a photosensor 1414. A lower waveguide 1420 is arranged near and parallel to waveguide 1400, as in previous embodiments. Two pairs 1430 and 1432 each comprising a light source and a patterned color filter inject light into waveguide 1420. Pairs 1430 and 1432 are “stacked” such that they produce light from the same location in the common plane of waveguides 1400 and 1420. Pair 1430 encodes positional information by emitting and modulating two distinct spectra of light A and B, as in previous embodiments. Pair 1432 similarly encodes positional information by emitting and modulating two distinct spectra of light C and D. A spectrum X is defined to be a union of spectra A and B, and a spectrum Y is defined to be a union of spectra C and D. The edges of waveguide 1400 are treated to diffusely reflect spectra X and Y. An edge 1426 of waveguide 1420 is treated to absorb spectrum X and specularly reflect spectrum Y, while all other edges of waveguide 1420 are treated to absorb both spectra X and Y. A downward force brings waveguides 1400 and 1420 into contact at a point 1412.

Light from pair 1430 travels in waveguide 1420 until reaching an edge where it is absorbed or until reaching point 1412 where part of the light travels into waveguide 1400. Light from pair 1430 traveling in waveguide 1400 strikes an edge at region 1404 where it is diffusely reflected, part of the reflected light then reaching photosensor 1414 where the positional information is decoded as for previous embodiments yielding a line from the location of pair 1430.

Some light from pair 1432 travels in waveguide 1420 until reaching point 1412 where it travels into waveguide 1400 and eventually strikes region 1402, where it is diffusely reflected, some of the reflected light reaching photosensor 1414. Other light from pair 1432 travels in waveguide 1420 until either reaching edge 1426 where it is reflected or reaching any other edge where it is absorbed. Edge 1426 acts as a mirror, forming a virtual image 1433 of pair 1432. Light reflected from edge 1426 then travels until being absorbed at another edge of waveguide 1420 or being coupled into waveguide 1400 at point 1412. Light reflected from edge 1426 coupled into waveguide 1400 then strikes a region 1404 where it is diffusely reflected, some of the reflected light then travelling to photosensor 1414.

Light from pairs 1430 and 1432 reaching photosensor 1414 produce signals which are made distinguishable by any appropriate means including carrier modulation. The signal produced by light from pair 1430 has only one component: the component corresponding to the light from pair 1430 diffusely reflected from region 1402. The signal produced by light from pair 1432, however, has two components: first and second components corresponding to the light produced by pair 1432 diffusely reflected from regions 1402 and 1404, respectively. The first component is equivalent to the signal produced by light from pair 1430 as both signals are produce by light traveling the same path through waveguides 1400 and 1420. The signal produced by light from pair 1430 is subtracted from the total signal produced by light from pair 1432 yielding the second component. The positional information of the second component is then decoded yielding a line from virtual image 1433, the intersection of which with the previously determined line from pair 1430 is the desired point 1412.

The electronic components of this embodiment including light sources and photosensor may be mounted very close together resulting in a smaller package and reduced electromagnetic interference (EMI) as a result of short electrical interconnections.

Edge 1426 may be constructed using many methods familiar to a skilled practitioner including mirroring a color filter and using an appropriate diffractive optical element (DOE).

The technique presented in the embodiment of FIG. 14 of treating an edge or edges of a waveguide to reflect some wavelengths of light while absorbing others may be used in combination with other methods of encoding positional information, including those presented in this application, as will be apparent to a skilled practitioner. In particular, pairs 1430 and 1432 may be replaced by light sources of different spectra, one reflected and one absorbed by mirrored edge 1426, and positional information encoded along the edges of waveguide 1400 as described for previous embodiments.

Further embodiments add to the embodiment of FIG. 14 an additional pair consisting of a light source and color filter and treat the edge of waveguide 1420 collinear with edge 1402 to specularly reflect light from the additional pair while absorbing light from all other light sources. The additional elements provide an additional “view” of point 1412 adding redundancy to and increasing the precision of the system.

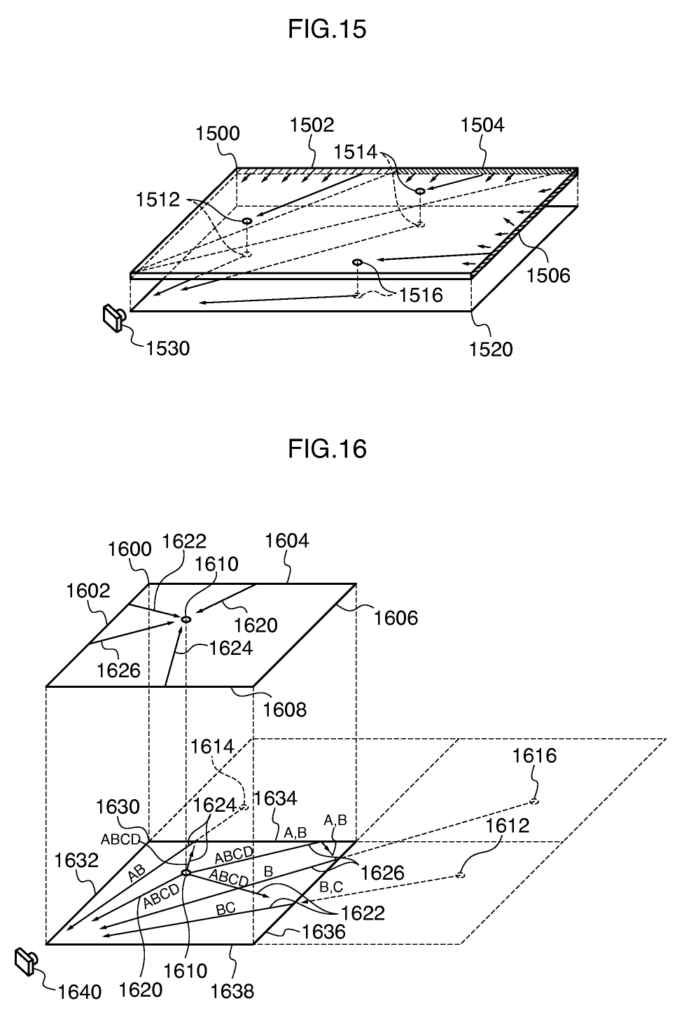

FIG. 15 shows an exploded view of yet another embodiment of the present invention. An upper waveguide 1500 is arranged near and parallel to a lower waveguide 1520. Light travels in waveguide 1500 from three regions 1502, 1504, and 1506 on edges of waveguide 1500, the light from each region having properties that distinguish it from light of other regions. As in previous embodiments light from waveguide 1500 is coupled into waveguide 1520 at points where force is applied. An imager 1530 captures light traveling in waveguide 1520 to form an image of points where light enters waveguide 1520. Imager 1530 is capable of distinguishing light originating from regions 1502, 1504, and 1506 and forms a three-channel image.

Downward forces not shown in FIG. 15 are applied at regions 1512, 1514, and 1516 coupling light from waveguide 1500 into waveguide 1520. Imager 1530 forms a three-channel image which includes regions 1512, 1514, and 1516. The light reaching imager 1530 from region 1512 originates from region 1502, as shown in FIG. 15. Likewise, the light reaching imager 1530 from regions 1514 and 1516 originate from regions 1504 and 1506, respectively. Therefore, each of regions 1512, 1514, and 1516 appear in separate channels of the three-channel image produced by imager 1530. The three regions 1502, 1504, and 1506 effectively divide the surface of the present embodiment into three triangular regions. Dividing a large surface into smaller regions is an important technique for increasing the number of different points that can be simultaneously detected by a coordinate input system, and also can reduce power requirements, as explained for the embodiments of FIGS. 5 and 6.

Imager 1530 may be implemented using any means familiar to a skilled practitioner including line cameras and two-dimensional cameras. The properties that distinguish light from regions 1502, 1504, and 1506 may include wavelength or color, carrier frequency, phase, or any other appropriate property.

An exploded view of yet another embodiment of the current invention is shown in FIG. 16. An upper waveguide 1600 having four edges 1602, 1604, 1606, and 1608 is arranged parallel and near to a lower waveguide 1630 also having four edges 1632, 1634, 1636, and 1638. Edges 1602, 1604, 1606, and 1608 each emit one spectra of light A, B, C, and D, respectively, which travel through waveguide 1600 and are coupled into waveguide 1630 at a region 1610. Edges 1632 and 1638 are treated to absorb all four spectra. Edge 1634 is treated to absorb light of spectra C and D while acting as a mirror for light of spectra A and B, as indicated in FIG. 16. Edge 1636 is treated to absorb light of spectra A and D while acting as a mirror for light of spectra B and C, also as indicated in FIG. 16.

Mirrored edges 1634 and 1636 form virtual images 1612, 1614, and 1616 of area 1610. An imaging system 1640 with four separate channels a, b, c, and d corresponding to spectra A, B, C, and D, respectively, forms an output image containing projections of area 1610 and virtual images 1612, 1614, and 1616. The projection of area 1610 is formed from light comprising spectra A, B, C, and D traveling along a path 1620. The projection of virtual image 1612 is formed from light traveling along a path 1622 comprising only spectra B and C, spectral components A and D having been absorbed by edge 1636. The projection of virtual image 1614 is formed from light traveling along a path 1624 comprising only spectra A and B, spectral components C and D having been absorbed by edge 1634. The projection of virtual image 1616 is formed from light travelling along a path 1626 comprising only spectra B, spectral components A, C, and D having been absorbed by edges 1634 and 1636.

Channel d of the output image contains only the projection of region 1610, which is subtracted from the remaining channels. Channels a and c then contain only one projection each, those of virtual images 1614 and 1612, respectively. Channels a and c are subtracted from channel b, leaving only the projection of virtual image 1616 in channel b. In this manner the projections of area 1610 and each virtual image are unambiguously “labeled” making the task of tracking easier. The separation of the projections of images from each of the four quadrants illustrated in FIG. 16 becomes even more important when multiple points are present simultaneously and overlap between some projections occurs, as separating or “labeling” projections substantially reduces overlap.

Although four channels are used in this embodiment, fewer channels may be used, the results being not entirely unambiguous but still very useful for labeling projections.

Further embodiments discard virtual image 1616 by configuring 1634 and 1636 to reflect only spectra A and B, respectively. In this case imaging system 1640 need only produce a three-channel image to unambiguously label each projection, permitting the use of commonly available three-channel “RGB” cameras.

Many embodiments have been described that determine the coordinates of a point or points of contact on a surface. Further embodiments produce an image of objects near to or possibly, but not necessarily, touching a surface. The image of nearby objects is processed using image processing techniques to determine properties of the objects including position and shape. These further embodiments describe, then, devices capable of producing images of the distribution of light incident on the surface of the devices.

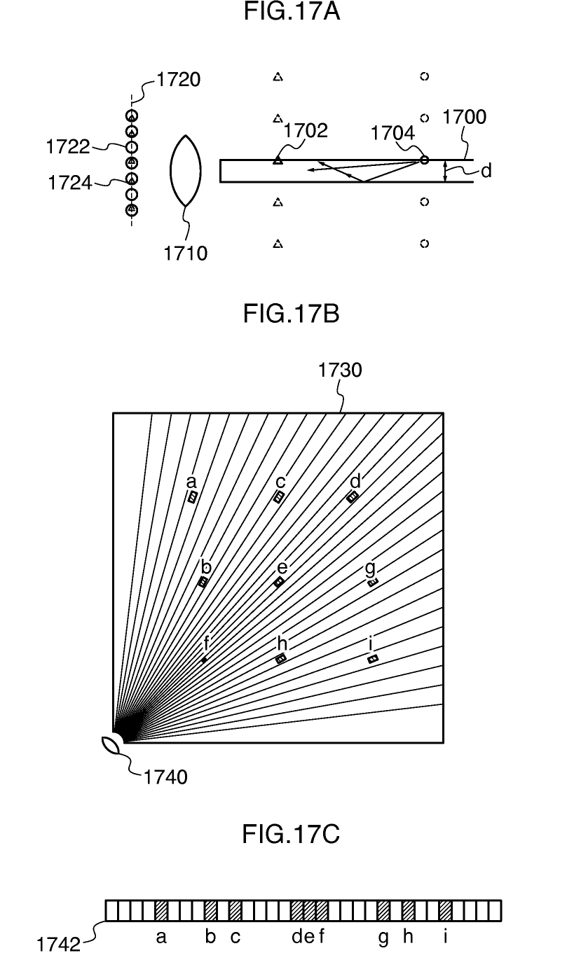

Referring to FIG. 17A, a photoluminescent waveguide 1700 of thickness d is shown next to an imager 1710 represented by a lens shape. FIG. 17A is a cross-sectional view, and waveguide 1700 has a planar shape. Stimulating light strikes waveguide 1700 at two points 1702 and 1704, represented in FIG. 17A as a triangle and circle, respectively. An image plane 1720 of imager 1710 is shown as a dashed line. As light propagates along waveguide 1700, top and bottom surfaces of waveguide 1700 act as mirrors creating virtual images of points 1702 and 1704 spaced at twice the thickness d of waveguide 1700. Imager 1710 forms projections of points 1702 and 1704 along with the virtual images on image plane 1720. Because the thickness d of waveguide 1700 is known and constant, the spacing of the projections of a point and the associated virtual images can be measured in imaging plane 1720 and used to compute the distance of the point using simple geometry. For example, in the case where the angular distance between point 1702 and an adjacent virtual image is measured to be a quantity alpha, the distance from the center of perspective of imager 1710 to point 1702 is simply 2d/tan(alpha).

FIG. 17B shows a top view of a photoluminescent waveguide 1730 and an imager 1740. Waveguide 1730 is patterned such that only shaded regions a-i shown in FIG. 17B are photoluminescent. When stimulating light strikes any of regions a-i some light is emitted by photoluminescence and propagates in waveguide 1730 until reaching imager 1740 which forms an image 1742. Imager 1740 has a vertical resolution of one and a horizontal resolution of 32, as shown in FIG. 17C. Each rectangular region in FIG. 17C represents one pixel in image 1742. Radial lines in FIG. 17B show the regions of waveguide 1730 which are mapped to pixels in image 1742. The intensity of stimulating light striking regions a-i is therefore given by the values of pixels correspondingly labeled a-i in FIG. 17C. Waveguide 1730 effectively forms a spatial light sensor sampling incident light at the plane of the device at regions a-i.

When operated in an environment where ambient light causes a photoluminescent emission in waveguide 1730, objects near to waveguide 1730 will cast shadows over the surface of waveguide 1730. An image of the shadows is formed by regions a-i, which can be interpreted using computer vision techniques familiar to a skilled practitioner.

As an example, a small, circular object placed on or near the surface of waveguide 1730 will cast a circular shadow. Regions a-i falling inside the shadow will not receive stimulating light from the environment and the corresponding pixels in image 1742 will remain dark. The pixels of image 1742 are rearranged as located on waveguide 1730 to construct an electronic image. Image processing techniques are then applied to find parameters such as the center and shape of the dark shadow formed by the circular object.

Examples of photoluminescent materials for the construction of waveguide 1730 include PMMA dyed with DFSB-C0 and Kuraray Comoglas 155K, both referenced in the co-pending '691 application. Comoglas 155K has an excitation spectrum which includes blue wavelengths commonly present in both incandescent and fluorescent lighting, making it suitable for the detection of shadows or measuring incident light in a wide variety of environments.

In the case of FIGS. 17B and 17C, the image formed by photoluminescent regions does not take full advantage of the resolution of imager 1740 (only nine of 32 pixels are used) and has a low resolution. Other embodiments may use higher resolution imagers and pattern a waveguide making full use of the imager's resolution to form a high-resolution image of light incident on the surface of the waveguide.

Still other embodiments similar to the embodiment of FIGS. 17B and 17C add a stimulating light source and detect not shadows of objects but the image of stimulating light reflected by nearby objects. Examples of appropriate stimulating light sources include light emitting diodes mounted around the periphery of the photoluminescent waveguide creating a lamina of light over the waveguide, a “leaky” waveguide propagating stimulating light, and any of the many techniques used to create “front lights” used to light reflective liquid crystal displays.

In these embodiments stimulating light from the light source present over the surface of the display is reflected by any nearby objects back towards waveguide 1730 where it induces a photoluminescent response in nearby photoluminescent regions. The photoluminescent regions nearest the objects will appear “brightest” in image 1742, producing a bright reconstructed image of the objects. Image processing techniques are then applied to find centers, shapes, etc. of the bright images of nearby objects.

Further embodiments of the present invention which image light incident on a photoluminescent waveguide use a two-dimensional (2D) imager. A 2D imager allows the placement of more than one photoluminescent region at the same angle with respect to the imager. Referring to FIGS. 17B and 17C, it can be seen that if two photoluminescent regions were placed in the same region denoted by radial lines in FIG. 17B, light from both regions would be mapped to the same pixel in image 1742. However, referring to FIG. 17A it can be seen that a photoluminescent point and its reflections are projected by a 2D imager forming projections with a spacing that depends on the distance separating the point and the imager. In the case of FIG. 17A, for example, point 1702 and its reflections are projected on image plane 1720 at the locations indicated by triangles. Point 1704 and its reflections are projected on image plane 1720 at the locations indicated by the circle centers. Note that the triangle and circle symbols on image plane 1720 are not to scale and indicate a position by their centers. One reflection of point 1704 is projected to a location 1722, and one reflection of point 1702 is projected to a location 1724 and do not overlap as would be the case for a one-dimensional imager. Thus, using a 2D imager, photoluminescent regions may be placed at the same angle with respect to an imager if at least one projection associated with each region does not coincide with a projection associated with any other region.

Any of the methods of signal separation described in the co-pending '691 application may be applied to increase the number of photoluminescent sample regions can be independently resolved by an imager. Examples include the use of a color imager and separate layers of sample regions created using photoluminescent materials with different emission spectra (“signal separation by emission spectrum”), signal separation by excitation spectrum, and the use of multiple imagers with multiple waveguides (“waveguide stacking”).

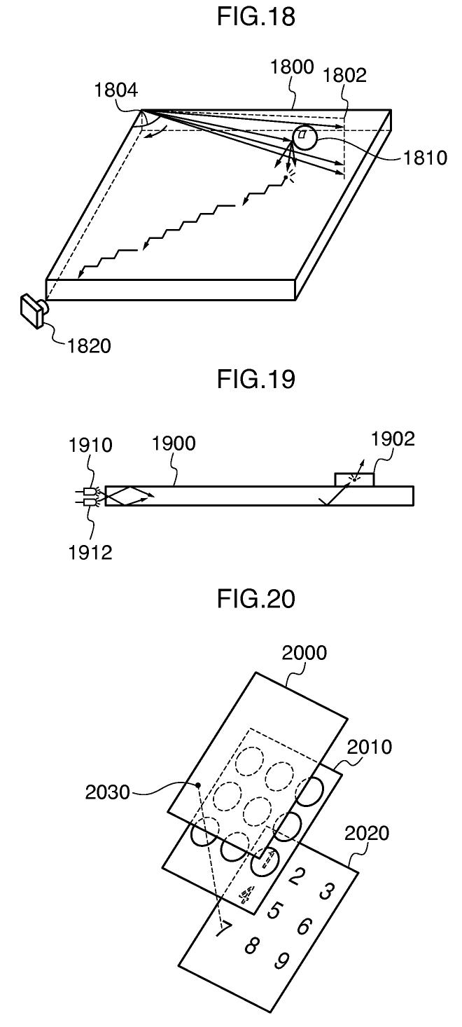

FIG. 18 illustrates yet another embodiment of the present invention. An object 1810 is positioned above a photoluminescent waveguide 1800. A light source not shown produces a lamina 1802 of stimulating light above waveguide 1800 forming an angle 1804 with one side of waveguide 1800. Lamina 1802 is swept such that angle 1804 decreases, as indicated in FIG. 18. Some light from lamina 1802 strikes object 1810 and is reflected toward waveguide 1800, causing photoluminescent material in waveguide 1800 to emit light, some of which propagates until reaching an imager 1820. Lamina 1802 is synchronized with imager 1820 which produces multiple output images as lamina 1802 is swept across waveguide 1800. The output images are cross-sectional “slices” which are combined to form an image of object 1802. The process may be repeated to form a stream of images of the area near the surface of waveguide 1800 which may be processed using computer vision techniques.

Further embodiments replace lamina 1802 of FIG. 18 with a second lamina of light created by injecting a first lamina of light into a “leaky” waveguide.

Still additional embodiments use multiple imaging systems either supplementing or replacing the virtual viewpoints created by mirrored edges in various previous embodiments.

Still other embodiments provide a light-conducting layer and a translucent, diffusing surface arranged parallel and near to the light-conducting layer. Any appropriate technique from this application is employed to cause light from the light-conducting layer to strike the diffusing surface. The diffusing surface scatters the light, resulting in a “spot” of light which may be tracked from either side of the surface using methods including video cameras and computer vision algorithms such as those described in U.S. Pat. Appl. 09562987 by Tulbert, which is incorporated herein by reference.

Other embodiments make use of waveguides which are not photoluminescent, but rather are configured to partially scatter incident light such that some of the light is propagated within the waveguide by internal reflection.

In various exemplary embodiments of the present invention, photoluminescent materials are used to be responsive to light conveyed by an optical waveguide. However, it is understood by those of ordinary skill in the art that other photo-responsive properties could be employed in place of photoluminescence. For example, materials exhibiting a photoelectric effect (coupled with electrical detectors) or other measurable responses to light can be employed in or coupled to the waveguides of the present invention.

Although many embodiments are described herein as comprising planar waveguides, it is understood by those of ordinary skill in the art that waveguides of any shape may be employed.

Still other embodiments of the present invention relate to information displays similar to those described in U.S. patent application Ser. Nos. 10/730,332 and 11/535,801 by Steckl and Heikenfeld, respectively, which are both incorporated herein by reference.

FIG. 19 is a cross-sectional view of a display device according to another embodiment of the present invention. A waveguide 1900 is in optical communication with a feature 1902 and two light sources 1910 and 1912. When activated, light source 1910 emits light of a spectrum A which propagates along waveguide 1900 by internal reflection. When activated, light source 1912 emits light of a spectrum B which likewise propagates along waveguide 1900 by internal reflection. Spectra A and B do not overlap. Feature 1902 is composed of a material which transmits light of spectra A and B and which has a refractive index near to that of waveguide 1900 such that light propagating in waveguide 1900 travels into feature 1902. Feature 1902 emits light of a spectrum C when illuminated by light of spectrum A and emits light of a spectrum D when illuminated by light of spectrum B. Spectra C and D are distinct and visible to the human eye.

Light sources 1910 and 1912 are independently controllable and therefore, the amounts of light of spectra C and D emitted from feature 1902 is also controllable. Varying the relative amounts of light of spectra C and D changes the color of feature 1902 perceived by a human observer. The ability to change the color of a feature patterned onto the surface of an electronic device makes possible indications of the status of the device and also pleasant visual effects.

Suitable materials for the construction of feature 1902 include PMMA dyed with DFSB-C0 and DFSB-C7 as described in the '691 application, which produces a red color when stimulated with 380 nm light and a blue color when stimulated with 395 nm light. LEDs are commonly available in this range. Materials suitable for the construction of waveguide 1900 include optical glasses and polymers with good transparency in the 370-395 nm range.

FIG. 20 shows an exploded view of an interactive surface device according to an additional embodiment of the present invention. An upper waveguide 2000 propagates stimulating light of a spectrum A emitted by a light source not shown. A second layer 2010 is arranged parallel to waveguide 2000 such that a substantial downward force on the device causes light to escape waveguide 2000 and pass into layer 2010. Layer 2010 is patterned with a photoluminescent material illustrated by circles in FIG. 20 which is excited by light of spectrum A. An optional third layer 2020 contains information to be displayed to a user of the device.

A downward force is applied at a point 2030 causing light from waveguide 2000 to pass into layer 2010 where it is absorbed by and excites nearby photoluminescent patterns which become visually emphasized providing feedback to the user. Although layers 2010 and 2020 may be configured to display any type of visual pattern, the device as illustrated in FIG. 20 forms a numerical keyboard with buttons that appear highlighted by circles when pressed.

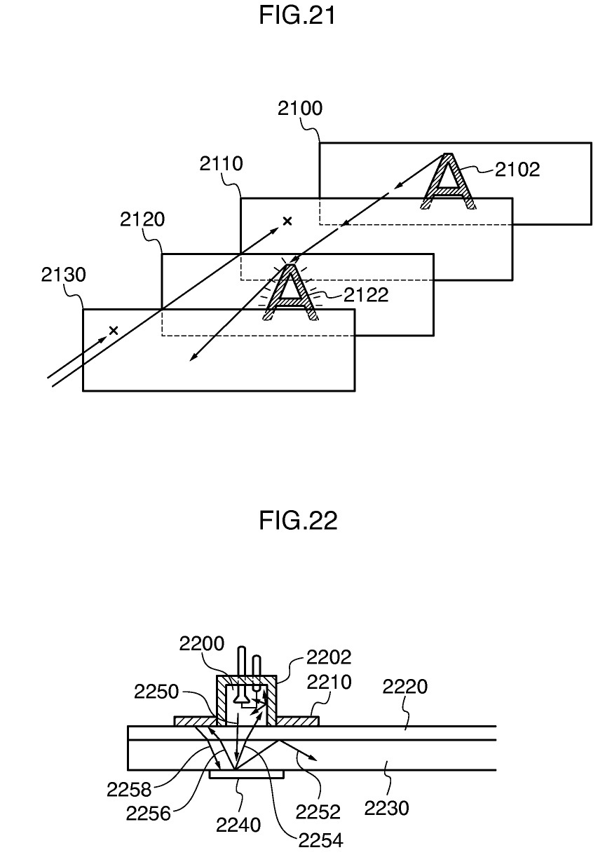

FIG. 21 is an exploded diagram of a display device according to another embodiment of the present invention. A display layer 2100 emits light of a spectrum A in a pattern 2102 which passes through a filter layer 2110 and strikes a photoluminescent layer 2120. Layer 2120 emits light of a spectrum B where struck by light of spectrum A, forming a second pattern 2122 which is a copy of pattern 2102. Layer 2110 passes light of spectrum A but absorbs light of spectrum B such that light emitted in layer 2120 traveling in the direction of layer 2100 is absorbed. Other light emitted in layer 2120 forming pattern 2122 travels through a second filter layer 2130 and exits the device forming a pattern visible to a user of the device. Layer 2130 passes light of spectrum B but absorbs light of spectrum A. Each of layers 2110, 2120, and 2130 preferably have refractive indices close to one another to minimize fresnel reflections at layer boundaries. Filter layers 2110 and 2130 may be designed so that, in combination, they completely absorb visible light, such that light from the environment surrounding the device is largely absorbed. When all visible light is absorbed by filter layers 2110 and 2130, all reflections of external light inside the device are suppressed resulting in a high contrast ratio even in bright conditions such as direct sunlight.

Display layer 2100 may be implemented using a liquid crystal display in combination with a backlight emitting appropriate wavelengths of light, or any other appropriate display means. Suitable materials for the construction of filter layers 2110 and 2130 include commonly available optical filters made of glass and polymers well known to those skilled in the art. The photoluminescent material of layer 2120 is preferably a dye rather than a powdered pigment which may reflect light from the environment reducing display contrast. If a powdered pigment is used, layer 2130 preferably absorbs wavelengths most strongly reflected by the pigment.

A method of coupling light into a waveguide 2230 according to still another embodiment of the present invention is illustrated in cross-section in FIG. 22. A light source 2200 emits light, some of which travels along a path 2250 through a cladding layer 2220 and through waveguide 2230 to strike a diffuse reflector layer 2240. Some of the light reflected by layer 2240 follows a path 2252 and, satisfying the requirements for TIR, is reflected at the boundary of waveguide 2230 and cladding layer 2220 and continues to propagate within waveguide 2230. Other light reflected by layer 2240 travels along a path 2254 through waveguide 2230 and layer 2220 back into light source 2200 before striking a coating 2202. Coating 2202 diffusely reflects the light, which eventually leaves light source 2200 to again strike layer 2240 where it is again diffusely reflected. Still other light reflected from layer 2240 travels along a path 2256 through waveguide 2230 and layer 2220 to strike retro-reflector 2210 which returns the light along a slightly offset path 2258 to layer 2240. In this way a large part of the light emitted by light source 2200 is recycled until satisfying the conditions for TIR, achieving a high efficiency.

Suitable light sources include light emitting diodes, and suitable materials to act as diffuse reflectors include barium sulfate and particles of titanium dioxide embedded in binder, a common formula for white paint. Retro-reflector 2210 may be of any type including the bead type and corner reflector type. Light efficiency may be improved by constructing retro-reflector 2210 using a corner reflector design with a material of refractive index close to that of cladding layer 2220, minimizing fresnel reflections at their boundary.

### CONCLUSION

Thus many devices and methods are provided to implement interactive surfaces in a compact, inexpensive manner.

Patents, patent applications, or publications mentioned in this specification are incorporated herein by reference to the same extent as if each individual document was specifically and individually indicated to be incorporated by reference.

While the above description contains many specificities, these should not be construed as limitations on the scope of the invention, but rather as exemplifications of preferred embodiments of the invention. Many other variations are possible.

What is claimed is:

1. A pressure-responsive optical system comprising:
a first optical waveguide configured to convey electromagnetic radiation, the first optical waveguide being deformable in response to pressure;
a second optical waveguide for receiving electromagnetic radiation positioned in proximity to the first optical waveguide such that pressure applied to the optical system causes the electromagnetic radiation to be coupled from the first optical waveguide to the second optical waveguide;
one or more electromagnetic radiation detectors configured to detect the electromagnetic radiation coupled from the first optical waveguide to second optical waveguide and to determine the position at which the electromagnetic radiation is coupled from the first optical waveguide to the second optical waveguide.

2. A pressure-responsive optical system as set forth in claim 1 further comprising an intermediate material positioned between said first waveguide and said second waveguide.

3. A pressure-responsive optical system as set forth in claim 2 wherein the intermediate material is microspheres.

4. A pressure-responsive optical system as set forth in claim 2 wherein the intermediate material is deformable is response to pressure on the optical system.

5. A pressure-responsive optical system as set forth in claim 1 wherein the second optical waveguide comprises a photoluminescent material having an excitation spectrum, at least a part of the excitation spectrum of the photoluminescent material overlapping the spectrum of the electromagnetic radiation conveyed by the first optical waveguide.

6. A pressure-responsive optical system as set forth in claim 1 further comprising a light source to supply the electromagnetic radiation.

7. A pressure sensitive optical system as set forth in claim 6 wherein the light source comprises first and second light sources.

8. A pressure-responsive optical system as set forth in claim 7 wherein the first light source propagates light in a portion of the first waveguide and the second light source propagates light is a second portion of the first waveguide different from the first portion of the first waveguide.

9. A pressure-responsive optical system as set forth in claim 8 wherein the first and second light sources are configured to sequentially propagate light and the one or more electromagnetic radiation detectors are configured to synchronously detect the light from the first and second light sources.

10. A pressure-responsive optical system as set forth in claim 7 wherein the second waveguide comprises at least first and second photoluminescent materials having first and second excitation spectrums, at least a part of the first excitation spectrum overlapping a spectrum of the electromagnetic radiation of the first light source and a least a part of the second excitation spectrum overlapping a spectrum of the electromagnetic radiation of the second light source.

11. A pressure-responsive optical system as set forth in claim 1 wherein the first optical waveguide comprises a photoluminescent material having an excitation spectrum at least a portion of which is responsive to ambient light, and the electromagnetic radiation conveyed by the first optical waveguide is light emitted by the photoluminescent material in response to ambient light.

12. A pressure-responsive optical system as set forth in claim 1 wherein the first optical waveguide comprises plural edges, each edge selectively reflecting different amounts of two or more colors of light in response to the electromagnetic radiation conveyed by the first optical waveguide, and the one or more electromagnetic radiation detectors comprise two electromagnetic radiation sensors which determine a ratio of an amount of the two or more colors of light from each edge to ascertain the location of pressure applied to the optical system.

13. A pressure-responsive optical system as set forth in claim 1 further comprising first and second light sources supplying the electromagnetic radiation conveyed by the first waveguide and wherein the first optical waveguide comprises plural edges, each edge selectively reflecting different amounts of two or more colors of light in response to the electromagnetic radiation conveyed by the first optical waveguide, and the one or more electromagnetic radiation detectors comprise a single electromagnetic radiation sensor which determines a ratio of an amount of the two or more colors of light from each edge to ascertain the location of pressure applied to the optical system.

14. A pressure-responsive optical system as set forth in claim 13 further comprising a second electromagnetic radiation sensor.

15. A pressure-responsive optical system as set forth in claim 1 wherein the electromagnetic radiation detector is a camera.

16. A pressure-responsive optical system as set forth in claim 15 wherein the first optical waveguide comprises plural first waveguide edges, each first waveguide edge selectively reflecting a different spectrum of light in response to the electromagnetic radiation conveyed by the first waveguide, and the second optical waveguide comprises plural second waveguide edges, each second waveguide edge selectively absorbing one or more spectra of light reflected by the first optical waveguide edges.

17. A pressure-responsive optical system as set forth in claim 16 wherein the camera detects images reflected by one or more second optical waveguide edges to determine the location of pressure applied to the optical system.

18. An optical system comprising:
a source of electromagnetic radiation which interacts with an object to be detected by the optical system;
an optical waveguide configured to convey at least a portion of electromagnetic radiation following interaction with the object to be detected, the optical waveguide having one or more photoluminescent regions, each of the one or more photoluminescent regions having a an excitation spectrum, at least a part of the excitation spectrum of the photoluminescent region overlapping the spectrum of the electromagnetic radiation conveyed by the optical waveguide,
an imager receiving the stimulated emission from the one or more photoluminescent regions to determine the location of the object to be detected by the optical system.
